(19) United States
(12) Patent Application Publication
(10) Pub. No.: US 2007/0172006 A1
(43) Pub. Date: Jul. 26, 2007

(54) METHOD AND CIRCUIT FOR SAMPLING DATA

(76) Inventors: Tzuen-Hwan Lee, Tai-Chung Hsien (TW); Lan-Lan Huang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/307,108

(22) Filed: Jan. 24, 2006

(51) Int. Cl. H04L 7/00

(52) U.S. Cl. 375/355

(57) ABSTRACT

A method for sampling data is disclosed. The method includes providing a first data and a second data, detecting a phase of the first data by a first clock, and sampling the second data by an inverted signal of the first clock.

### BACKGROUND OF THE INVENTION

1. Field of the Invention

The present invention relates to a clock and data recovery circuit, and more particularly, to a clock and data recovery circuit utilizing an input data frequency divider to divide the frequency of the input data for lowering the clock rate and related method thereof.

2. Description of the Prior Art

The data stream received by a receiver is asynchronous. For subsequent processing, timing information, such as a clock, must be extracted from the data so as to allow synchronous operations. Furthermore, the data must be retimed such that the jitter accumulated during transmission is removed. The task of clock extraction and data retiming is called “clock and data recovery”. Clock and data recovery circuits must satisfy stringent specifications defined by related receiver standards, presenting difficult challenges to system and circuit designs.

The clock and data recovery circuit and the method for clock and data recovery can be used for many applications, e.g. for synchronous optical networks (SONET), synchronous digital hierarchic networks (SDH), networks operated in a synchronous transfer mode (ATM), local area networks (LAN), plesiochronous digital hierarchic networks (PDH), or serial-link applications such as SATA interface or PCI-Express interface.

Please refer to FIG. 1. FIG. 1 is a waveform diagram illustrating operation of prior art clock and data recovery. Please note that the input data DᵢₙB shown in FIG. 1 is an inverted signal of the input data Dᵢₙ, and both data, Dᵢₙ and DᵢₙB, come from a common signal source. As shown in FIG. 1, the recovered clocks CK_{Q} and CK_{QB} are utilized to sample the input data Dᵢₙ to obtain the recovered data Dₒᵤₜ, for example, D[0]−D[3] for input data Dᵢₙ and D[0]B−D[3]B for the input data DᵢₙB. The other recovered clocks CK_{I} and CK_{IB} are utilized to detect the phase relationship between the input data Dᵢₙ and the recovered clocks CK_{I}, and CK_{IB}. Additionally, suppose that the data rate of the input data Dᵢₙ, DᵢₙB is 2.5 Gbps. The clock rate of each recovered clock CK_{I}, CK_{IB}, CK_{Q}, CK_{QB} should be 1.25 Ghz.

Please refer to FIG. 2 in conjunction with FIG. 1. FIG. 2 shows a prior art clock and data recovery circuit 100. The clock and data recovery circuit 100 performs two main tasks. The first task is utilizing this system to recover input data, and the second task is recovering the system clock. As shown in FIG. 2, the clock and data recovery circuit 100 includes a decision circuit 110, a phase detection unit 120, a loop filter 130, a phase shifter 140, and a clock source 150. The clock and data recovery circuit 100 utilizes the phase detection unit 120 to sample an input data Dᵢₙ according to recovered clocks CK_{I}, and CK_{IB} generated from the phase shifter 140, and then converts the input data Dᵢₙ into an error signal Eᵣ having phase error values associated with the aforementioned recovered clocks. The operation of phase detection is illustrated in FIG. 1. Furthermore, it should be noted that recovered clock CK_{IB} is an inverted signal of the recovered clock signal CK_{I}, and recovered clock CK_{QB} is an inverted signal of the recovered clock signal CK_{Q}. Additionally, the recovered clocks CK_{I}, CK_{Q}, CK_{IB}, and CK_{QB} correspond to four different phases. Next, the loop filter 130 filters the error signal Eᵣ to generate a control signal C. The clock source 150, which can be a phase-locked loop (PLL) or a delay-locked loop (DLL), is implemented to provide the phase shifter 140 with a reference clock CLK_{ref}. By referring to the control signal C outputted from the loop filter 130, the phase shifter 140 is able to generate the recovered clocks CK_{I}, CK_{Q}, CK_{IB}, and CK_{QB}. Then, referring to FIG. 1, the decision circuit 110 utilizes the recovered clocks CK_{Q} and CK_{QB} to sample the input data Dᵢₙ to obtain the recovered data Dₒᵤₜ.

The prior art clock and data recovery circuit 100 has two shortcomings. The architecture shown in FIG. 2 does not utilize all of the recovered clocks for either of phase detection and data recovery. As described above, the recovered clocks CK_{Q} and CK_{QB} are utilized to sample the input data Dᵢₙ, while the recovered clocks CK_{I} and CK_{IB} are utilized to detect the phase relationship between the input data Dᵢₙ and the recovered clocks CK_{I} and CK_{IB}. The other shortcoming is that the clock frequency has to be maintained at a high operating frequency to match the high data rate of the input data Dᵢₙ. This means the system requires a high operating frequency controllable oscillator (e.g. voltage-controlled oscillator) in the PLL (i.e. the clock source 150) to provide the desired high-speed clock rate. In addition, the high-speed data rate will increase the difficulty in designing the clock and data recovery circuit 100.

### SUMMARY OF THE INVENTION

One objective of the claimed invention is therefore to provide a clock and data recovery circuit utilizing an input data frequency divider to divide the frequency of the input data for lowering the clock rate and related method thereof, to solve the above-mentioned problems.

According to an embodiment of the claimed invention, a method for sampling data is disclosed. The method includes: providing a first data and a second data; detecting a phase of the first data by a first clock while the clock is sampling the second data.

In addition, the claimed invention further provides a circuit for sampling data. The circuit includes a data provider providing a first data and a second data; a clock provider providing a first clock and a second clock; a phase detection unit coupled to the data provider and the clock provider, the phase detection unit detecting a phase of the first data by the first clock, and detecting a phase of the second data by the second clock; and a decision circuit coupled to the data provider and the clock provider, the decision circuit sampling the first data by the second clock, and sampling the second data by the first clock.

This invention provides a method and apparatus to lower the clock rate of the clock and data recovery circuit. Compared with the prior art, the clock and data recovery circuit of the present invention can enable the decision circuit and the clock recovery loop circuits to operate at a lower clock rate since the input data frequency is lowered by the input data frequency divider. In this way, the complexity of the clock and data recovery circuit is greatly reduced because the required clock rate of the circuits is reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a waveform diagram illustrating operation of prior art clock and data recovery.

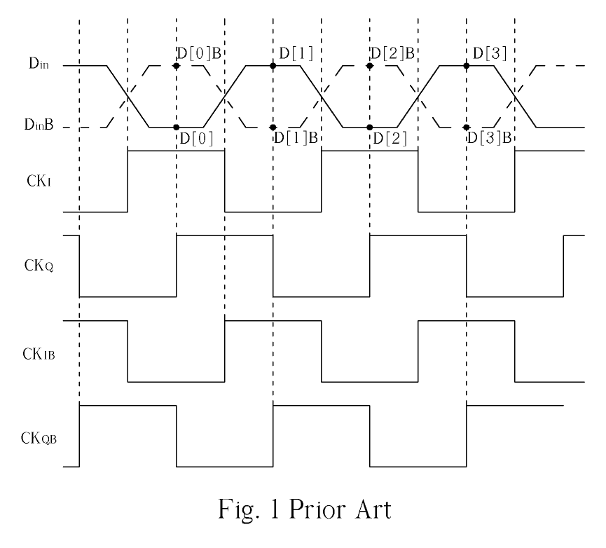

FIG. 2 shows a prior art clock and data recovery circuit.

FIG. 3 is a waveform diagram illustrating operation of a clock and data recovery according to the present invention.

FIG. 4 is a diagram of a clock and data recovery circuit according to an embodiment of the present invention.

FIG. 5 is a diagram of an embodiment of an input data frequency divider shown in FIG. 4.

FIG. 6 is a circuit diagram illustrating an embodiment of a decision circuit shown in FIG. 4.

FIG. 7 is a flowchart illustrating a clock and data recovery method according to an embodiment of the present invention.

### DETAILED DESCRIPTION

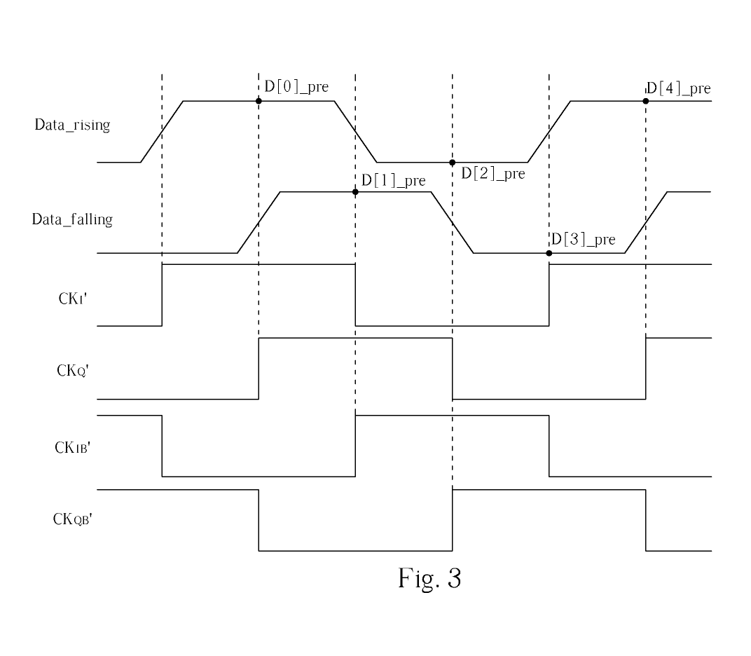

Please refer to FIG. 3. FIG. 3 is a waveform diagram illustrating operation of the clock and data recovery according to the present invention. In this embodiment, all of the recovered clocks CK_{I}′, CK_{Q}′, CK_{IB}′, CK_{QB}′ are used in a phase detection operation to detect the phase relationship between the recovered clocks CK_{I}′, CK_{Q}′, CK_{IB}′, CK_{QB}′ and the first and the second adjusted data Data_rising, Data_falling. The recovered clocks CK_{I}′ and CK_{IB}′ are used to detect the phase error of the first adjusted data Data_rising. The recovered clocks CK_{Q}′ and CK_{QB}′ are used to detect the phase error of the second adjusted data Data_falling. In addition, all of the recovered clocks CK_{I}′, CK_{Q}′, CK_{IB}′, CK_{QB}′ are used in a data recovery operation to generate the recovered data Dₒᵤₜ′. In short, in contrast to the prior art using part of the recovered clocks, the present invention uses the recovered clocks in an efficient way. In addition, in this embodiment the first and the second adjusted data Data_rising, Data_falling are generated by dividing frequency of an input data. Therefore, suppose that the data rate of the input data is 2.5 Gbps. With the help of the input data frequency dividing operation, the date rate of the first adjusted input data Data_rising becomes 1.25 Gbps, and the date rate of the second adjusted input data Data_falling becomes 1.25 Gbps. As a result, the clock rate of each recovered clock CK_{I}′, CK_{IB}′, CK_{Q}′, CK_{QB}′ is only 625 Mhz. Compared with the prior art clock and data recovery circuit demanding the clock rate of 1.25 Ghz, the clock rate of the present invention is lowered. The detailed operation of the clock and data recovery scheme of the present invention is described as below.

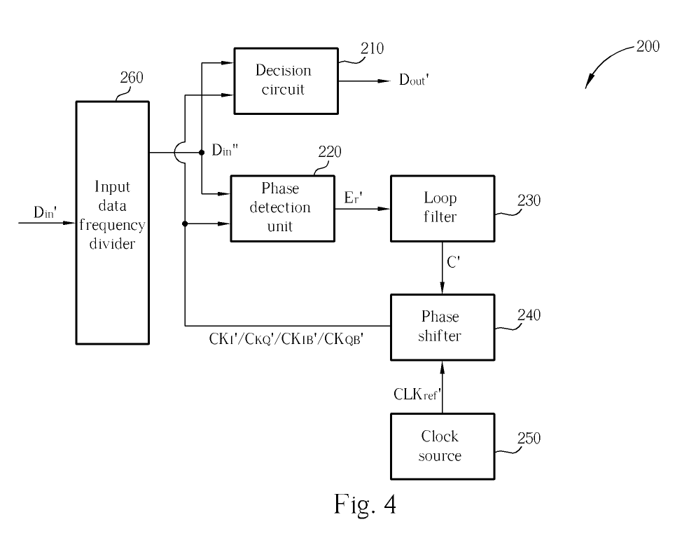

Please refer to FIG. 4. FIG. 4 is a diagram of a clock and data recovery circuit 200 according to an embodiment of the present invention. The clock and data recovery circuit 200 is used for generating recovered clocks that are locked to the adjusted input data Dᵢₙ″ and for recovering the input data Dᵢₙ′. As shown in FIG. 4, the clock and data recovery circuit 200 includes a decision circuit 210, a phase detection unit 220, a loop filter 230, a phase shifter 240, a clock source 250, and an input data frequency divider 260. The input data frequency divider 260, coupled to the input data Dᵢₙ′, serves as a data provider and is used for dividing the frequency of the input data Dᵢₙ′ to generate an adjusted input data Dᵢₙ″, where the operation of the input data frequency divider 260 is detailed later. The phase detection unit 220, coupled to the input data frequency divider 260, is used for generating a phase error signal Eᵣ′ representing a phase error between the adjusted input data Dᵢₙ″ and recovered clocks CK_{I}′, CK_{Q}′, CK_{IB}′, CK_{QB}′. It should be noted that recovered clock CK_{IB}′ is an inverted signal of the recovered clock signal CK_{I}′, and recovered clock CK_{QB}′ is an inverted signal of the recovered clock signal CK_{Q}′. Additionally, the recovered clocks CK_{I}′, CK_{Q}′, CK_{IB}′, and CK_{QB}′ correspond to four different phases. The loop filter 230, coupled to the phase detection unit 220, is used for filtering the phase error signal Eᵣ′ and generating a control signal C′. The phase shifter 240, coupled to the loop filter 230, the clock source 250, the decision circuit 210 and the phase detection unit 220, serves as a clock provider and is used for generating the desired recovered clocks CK_{I}′, CK_{Q}′, CK_{IB}′, and CK_{QB}′ by phase-shifting a reference clock CLK_{ref}′ according to the control signal C′. The clock source 250, coupled to the phase shifter 240, is used for generating the reference clock CLK_{ref}′. The decision circuit 210, coupled to the input data frequency divider 260 and the phase shifter 240, is used for generating a recovered data Dₒᵤₜ′ according to the adjusted input data Dᵢₙ″ and the recovered clocks CK_{I}′, CK_{Q}′, CK_{IB}′, and CK_{QB}′. Please note that in this embodiment the clock source 250 can be implemented by a phase-locked loop (PLL) or a delay-locked loop (DLL). However, these implementations are not meant to be limitations of the present invention.

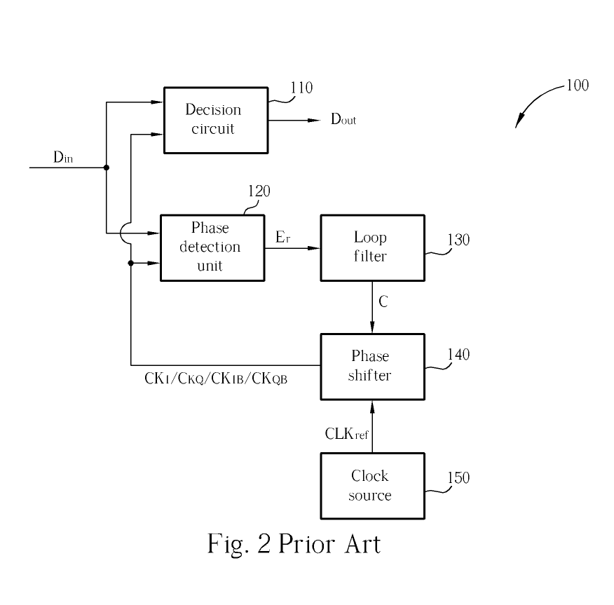

In the embodiment shown in FIG. 4, the key component is the input data frequency divider 260. Compared with the prior art clock and data recovery circuit 100 shown in FIG. 2, this invention utilizes the input data frequency divider 260 to lower the clock rate needed by the clock and data recovery circuit 200. The main objective of this invention is to implement an input data frequency divider 260 to lower the frequency of the input data Dᵢₙ′ for the following signal processing, thereby simplifying the circuit design of the next stage.

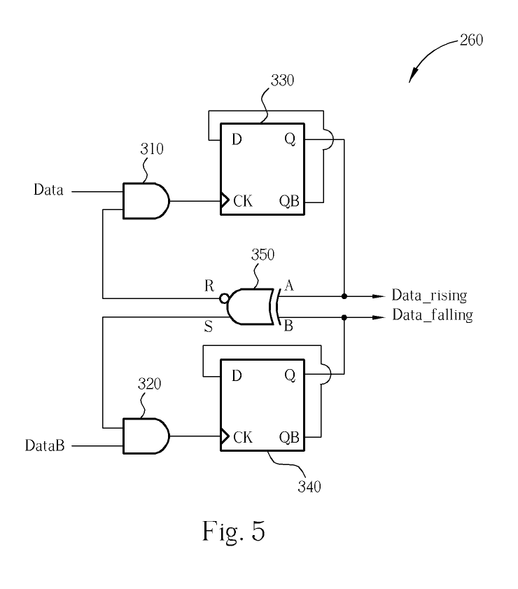

Please refer to FIG. 5. FIG. 5 is a diagram of an embodiment of the input data frequency divider 260 shown in FIG. 4. In this embodiment, the input data frequency divider 260 includes a first D flip-flop (DFF) 330, a second D flip-flop 340, a first AND gate 310, a second AND gate 320 and a combination logic 350. The input data Dᵢₙ′ of the clock and data recovery circuit 200 is usually a differential data including a first data Data and a second data DataB. It should be noted that the second data DataB is an inverted signal of the first data Data, and both the first data Data and the second data DataB come from a common signal source. The first data Data and the second data DataB are separately processed to generate the aforementioned adjusted output data Dᵢₙ″ including a first adjusted data Data_rising associated with the first data Data, and a second adjusted data Data_falling associated with the second data DataB. The generation of the first adjusted data Data_rising and the second adjusted data Data_falling and the operation of the input data frequency divider 260 is detailed as follows.

The combination logic 350 can operate as an XOR gate or an XNOR gate. The combination logic 350 has a first input node A coupled to the non-inverted data output node Q of the first DFF 330; a second input node B coupled to the non-inverted data output node Q of the second DFF 340; a first output node R; and a second output node S. The combination logic 350 generates an output at the first output node R by XNORing inputs at the first and second input nodes A, B and generates an output at the second output node S by XORing inputs at the first and second input nodes A, B.

The first AND gate 310 performs an AND logic operation upon the first data Data and the output at the first output node R of the combination logic 350, and then outputs a result to the clock input node CK of the first DFF 330. In other words, the first DFF 330 is triggered by “riging” edges of the first data Data, thereby generating the desired first adjusted data Data_rising. The second AND gate 320 performs an AND logic operation upon the second data DataB and an output at the second output node S of the combination logic 350, and then outputs a result to the clock input node CK of the second DFF 340. In other words, the second DFF 340 is triggered by “rising” edges of the second data DataB, thereby generating the desired second adjusted data Data_falling. Please note that, the first adjusted data Data_rising and the second adjusted data Data_falling are generated according to the first data Data and the second data DataB, respectively. The second adjusted data Data_falling should not regard as an inverted signal of the first adjusted data Data_rising.

As shown in FIG. 5, the inverted data output node QB is connected to the data input node D in both DFFs 330 and 340. In other words, both DFFs 330, 340 act as a frequency divider with a frequency-dividing factor equaling two. Therefore, the frequency of the input data Dᵢₙ′ is twice that of either of the first adjusted data Data_rising and the second adjusted data Data_falling through the utilization of the first and the second DFFs 330 and 340. It should be noted that the adjusted input data Dᵢₙ″ consists of the first adjusted data Data_rising and the second adjusted data Data_falling each having the frequency half that of the input data Dᵢₙ′. However, the data rate of the adjusted input data Dᵢₙ″ is equivalent to that of the input data Dᵢₙ′.

Please note that the implementation of the first and second AND gates 310, 320 and the combination logic 350 is for making the first and the second adjusted data Data_rising, Data_falling correctly represent the input data (i.e., Data and DataB). And these circuits (i.e., AND gates 310, 320 and combination logic 350) can be implemented in any similar or equivalent logic. But these implementations are not meant to be limitations of the present invention.

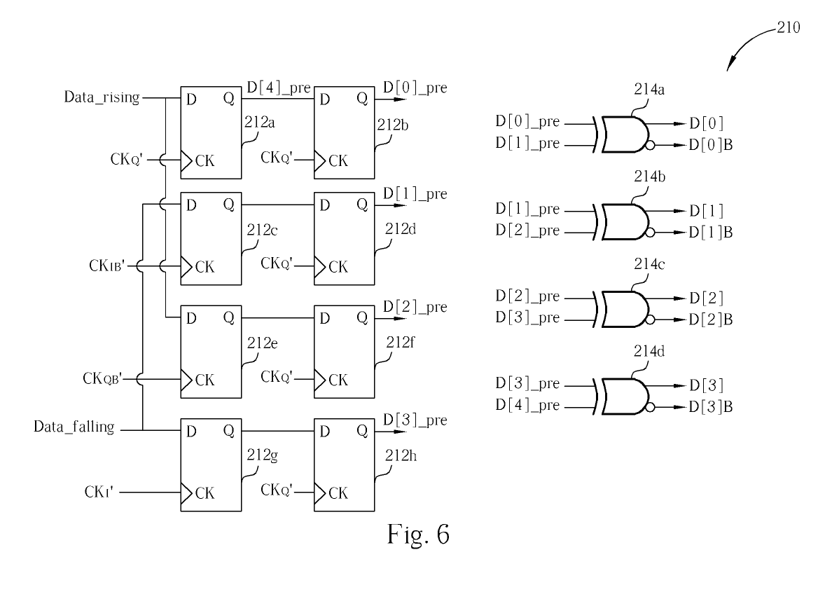

Please refer to FIG. 6 in conjunction with FIG. 3. FIG. 6 is an embodiment of the decision circuit 210 shown in FIG. 4. The decision circuit 210 includes a plurality of DFFs 212a-212h and a plurality of combination logics 214a-214d. The operation of the DFFs 212a-212h and combination logics 214a-214d has been detailed above, and further description is omitted for brevity. As shown in FIG. 3, the first adjusted data Data_rising is sampled at rising edges of the recovered clock CK_{Q}′ to obtain D[0]_pre and D[4]_pre sequentially. In addition, the first adjusted data Data_rising is further sampled at the rising edge of the recovered clock CK_{QB}′ to obtain D[2]_pre. As to the second adjusted data Data_falling, it is sampled at rising edges of the recovered clocks CK_{IB}′ and CK_{I}′ to obtain D[1]_pre and D[3]_pre, respectively. Then, the combination logics 214a-214d process the outputs of the DFFs 212a, 212b, 212d, 212f, 212f to successfully get the desired recovered data D[0]-D[3] and D[0]B-D[3]B.

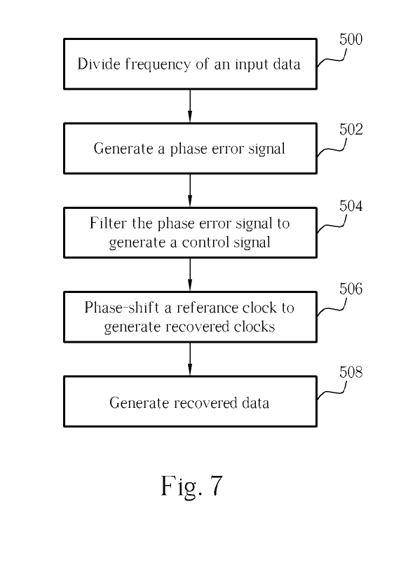

Please refer to FIG. 7. FIG. 7 is a flowchart illustrating a clock and data recovery method according to an embodiment of the present invention. The clock and data recovery method is performed by the aforementioned clock and data recovery circuit 200, and is summarized as follows.

Step 500: Divide the frequency of input data to generate adjusted input data;

Step 502: Generate a phase error signal representing a phase error between the adjusted input data and recovered clocks;

Step 504: Filter a phase error signal and generate a control signal;

Step 506: Phase-shift a reference clock to generate recovered clocks according to the control signal; and

Step 508: Generate a recovered data according to adjusted input data and recovered clocks.

It should be noted that the clock and data recovery method is performed by the aforementioned clock and data recovery circuit 200 and the detailed operations associated with phase detection and data recovery are clearly illustrated in above paragraphs and corresponding figures. Therefore, further description is omitted for brevity.

This invention provides a method and apparatus to lower the clock rate required by the clock and data recovery circuit. Compared with the prior art, the clock and data recovery circuit of the present invention can enable the decision circuit and the clock recovery loop circuits to operate at a lower clock rate since the input data is processed by the input data frequency divider to generate adjusted input data of lower frequency. In this way, the complexity of the clock and data recovery circuit is greatly reduced because the required clock rate of the circuits is reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for sampling data, comprising:
providing a first data and a second data;
detecting a phase of the first data by a first clock; and
sampling the second data by an inverted signal of the first clock.

2. The method of claim 1, wherein the step of providing the first data and the second data comprises:
receiving a differential input data including a first input data and a second input data;
dividing frequencies of the first and second input data to generate the first data and the second data, respectively.

3. The method of claim 1, further comprising:
sampling the second data by the first clock when detecting the phase of the first data by the first clock; and
detecting a phase of the first data by the inverted signal of the first clock when sampling the second data by the inverted signal of the first clock.

4. The method of claim 3, further comprising:
sampling the first data by a second clock; and
detecting a phase of the second data by the inverted signal of the second clock;
wherein a phase of the first clock is different a phase of the second clock.

5. The method of claim 4, further comprising:
sampling the first data by the inverted signal of the second clock when detecting the phase of the second data by the inverted signal of the second clock; and
detecting a phase of the second data by the second clock when sampling the first data by the second clock.

6. The method of claim 5, wherein the step of providing the first data and the second data comprises:
receiving a differential input data including a first input data and a second input data;
dividing frequencies of the first and second input data to generate the first data and the second data, respectively.

7. The method of claim 6, further comprising:
obtaining a recovered data corresponding to the input data by combining sampling results of the steps of sampling the second data by the inverted signal of the first clock, sampling the second data by the first clock, sampling the first data by the second clock, and sampling the first data by the inverted signal of the second clock.

8. The method of claim 1, further comprising:
sampling the first data by a second clock; and
detecting a phase of the second data by the inverted signal of the second clock;
wherein a phase of the first clock is different a phase of the second clock.

9. The method of claim 8, further comprising:
sampling the first data by the inverted signal of the second clock when detecting the phase of the second data by the inverted signal of the second clock; and
detecting a phase of the second data by the second clock when sampling the first data by the second clock.

10. The method of claim 1, further comprising:
sampling the first data by the inverted signal of a second clock; and
detecting a phase of the second data by the second clock.

11. A circuit for sampling data, comprising:
a data provider providing a first data and a second data;
a clock provider providing a first clock and an inverted signal of the first clock;
a phase detection unit coupled to the data provider and the clock provider, the phase detection unit detecting a phase of the first data by the first clock; and
a decision circuit coupled to the data provider and the clock provider, the decision circuit sampling the second data by the inverted signal of the first clock.

12. The circuit of claim 11, wherein the data provider in an input data frequency divider, and the input data frequency divider receives a differential input data including a first input data and a second input data, and divides frequencies of the first and second input data to generate the first data and the second data, respectively.

13. The circuit of claim 12, wherein the input data frequency divider comprises:
a first D flip-flop (DFF) having a non-inverted data output node for outputting the first data corresponding to the first input data; an inverted data output node; a data input node coupled to the inverted data output node of the first DFF; and a clock input node;
a second D flip-flop having a non-inverted data output node for outputting the second data corresponding to the second input data; an inverted data output node; a data
input node coupled to the inverted data output node of the second DFF; and a clock input node;
a combination logic having a first input node coupled to the non-inverted data output node of the first DFF; a second input node coupled to the non-inverted data output node of the second DFF; a first output node; and a second output node, wherein the combinational logic generates an output at the first output node by XNOR inputs at the first and second input nodes and generates an output at the second output node by XOR inputs at the first and second input nodes;
a first AND gate having a first input node for receiving the first input data; a second input node, coupled to the first output node of the combinational logic, for receiving the output at the first output node of the combinational logic; and an output node, coupled to the clock input node of the first DFF; and
a second AND gate having a first input node for receiving the second input data; a second input node, coupled to the second output node of the combinational logic, for receiving the output at the second output node of the combinational logic; and an output node, coupled to the clock input node of the second DFF.

14. The circuit of claim 11, wherein the decision circuit further samples the second data by the first clock when the phase detection unit detects the phase of the first data by the first clock, and the phase detection unit further detects a phase of the first data by the inverted signal of the first clock when the decision circuit samples the second data by the inverted signal of the first clock.

15. The circuit of claim 14, wherein the clock provider further provides a second clock and an inverted signal of the second clock, a phase of the first clock is different a phase of the second clock, the decision circuit further samples the first data by the second clock, and the phase detection unit further detects a phase of the second data by the inverted signal of the second clock.

16. The circuit of claim 15, wherein the decision circuit further samples the first data by the inverted signal of the second clock when the phase detection unit detects the phase of the second data by the inverted signal of the second clock, and the phase detection unit further detects a phase of the second data by the second clock when the decision circuit samples the first data by the second clock.

17. The circuit of claim 16, wherein the data provider is an input data frequency divider, and the input data frequency receives a differential input data including a first input data and a second input data, and divides frequencies of the first and second input data to generate the first data and the second data, respectively.

18. The circuit of claim 17, wherein the input data frequency divider comprises:
a first D flip-flop (DFF) having a non-inverted data output node for outputting the first data corresponding to the first input data; an inverted data output node; a data input node coupled to the inverted data output node of the first DFF; and a clock input node;
a second D flip-flop having a non-inverted data output node for outputting the second data corresponding to the second input data; an inverted data output node; a data input node coupled to the inverted data output node of the second DFF; and a clock input node;
a combination logic having a first input node coupled to the non-inverted data output node of the first DFF; a second input node coupled to the non-inverted data output node of the second DFF; a first output node; and a second output node, wherein the combinational logic generates an output at the first output node by XNOR inputs at the first and second input nodes and generates an output at the second output node by XOR inputs at the first and second input nodes;
a first AND gate having a first input node for receiving the first input data; a second input node, coupled to the first output node of the combinational logic, for receiving the output at the first output node of the combinational logic; and an output node, coupled to the clock input node of the first DFF; and
a second AND gate having a first input node for receiving the second input data; a second input node, coupled to the second output node of the combinational logic, for receiving the output at the second output node of the combinational logic; and an output node, coupled to the clock input node of the second DFF.

19. The circuit of claim 17, wherein the decision circuit further obtains a recovered data corresponding to the input data by combining sampling results of sampling the second data by the inverted signal of the first clock, sampling the second data by the first clock, sampling the first data by the second clock, and sampling the first data by the inverted signal of the second clock provided by the phase detection unit.

20. The circuit of claim 11, wherein the clock provider further provides a second clock and an inverted signal of the second clock, the decision circuit further samples the first data by the second clock, and the phase detection unit further detects a phase of the second data by the inverted signal of the second clock.

21. The circuit of claim 20, wherein the decision circuit further samples the first data by the inverted signal of the second clock when the phase detection unit detects the phase of the second data by the inverted signal of the second clock, and the phase detection unit further detects a phase of the second data by the second clock when the decision circuit samples the first data by the second clock.

22. The circuit of claim 11, wherein the clock provider further provides a second clock and an inverted signal of the second clock, the decision circuit further samples the first data by the inverted signal of the second clock, and the phase detection unit further detects a phase of the second data by the second clock.
